(19) United States
(12) Patent Application Publication
(10) Pub. No.: US 2008/0141310 A1
(43) Pub. Date: Jun. 12, 2008

(54) System and method for managing content on a digital video recorder

(75) Inventor: Gerard K. Kunkel, Yardley, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 11/635,175

(22) Filed: Dec. 7, 2006

(51) Int. Cl. G06F 13/00

(52) U.S. Cl. 725/58

(57) ABSTRACT

A system for managing a digital video recorder includes a transceiver for receiving program signals from a media source and for transmitting the program signals to a display device. The transceiver is further operative to transmit information regarding the digital video recorder to the display device to generate a user-interface management screen on the display device for use in managing operation of the digital video recorder. The information includes data that is indicative of available recording space on the digital video recorder based on current and scheduled recordings.

### BACKGROUND OF THE INVENTION

1. Field of the Invention

The invention relates to a system and method a digital video recorder.

2. Background Art

Digital video recorders may be used to record programs directly onto a hard drive. Digital video recorders may also be used to control live television with functions like pause, play and rewind.

### SUMMARY OF THE INVENTION

Under the invention, a new system and method for managing a digital video recorder are provided. In one embodiment, the system includes a transceiver for receiving program signals from a media source and for transmitting the program signals to a display device. The transceiver is further operative to transmit information regarding the digital video recorder to the display device to generate a user-interface management screen on the display device for use in managing operation of the digital video recorder. The information includes data that is indicative of available recording space on the digital video recorder based on current and scheduled recordings.

In another embodiment, the system includes a transceiver for receiving program signals from a media source and for transmitting the program signals to a display device. The transceiver is further configured to transmit information regarding the digital video recorder to the display device to generate a user-interface management screen on the display device for use in managing the digital video recorder. The management screen includes a video window that displays one of the program signals, and further includes the information regarding the digital video recorder.

In yet another embodiment, the system includes a transceiver for receiving program signals from a media source and for transmitting information to a display device for generating a user-interface management screen on the display device for use in managing content on the digital video recorder. The management screen is configured to include multiple video windows that display multiple program signals, and status information regarding the digital video recorder. The status information includes number of current recordings, number of scheduled recordings, time of recorded material, time of recorded material plus scheduled recordings, percent of storage capacity utilized by current recordings, and percent of storage capacity utilized when both current and scheduled recordings are added together.

Further under the invention, a method for managing a digital video recorder includes generating, via a transceiver, a user-interface management screen on a display device for use in managing operation of the digital video recorder. The management screen includes data that is indicative of available recording space on the digital video recorder based on current and scheduled recordings. Moreover, the transceiver is operative to receive program signals from a media source and to transmit the program signals to the display device for display on the display device.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic view of a system according to the invention for managing operation of a digital recording device, wherein the system includes a transceiver for receiving signals from a media source and for transmitting the signals to a display device, and a digital video recorder in communication with the transceiver; and

FIG. 2 is a view of a user-interface management screen generated by the transceiver and displayed on the display device.

### DETAILED DESCRIPTION

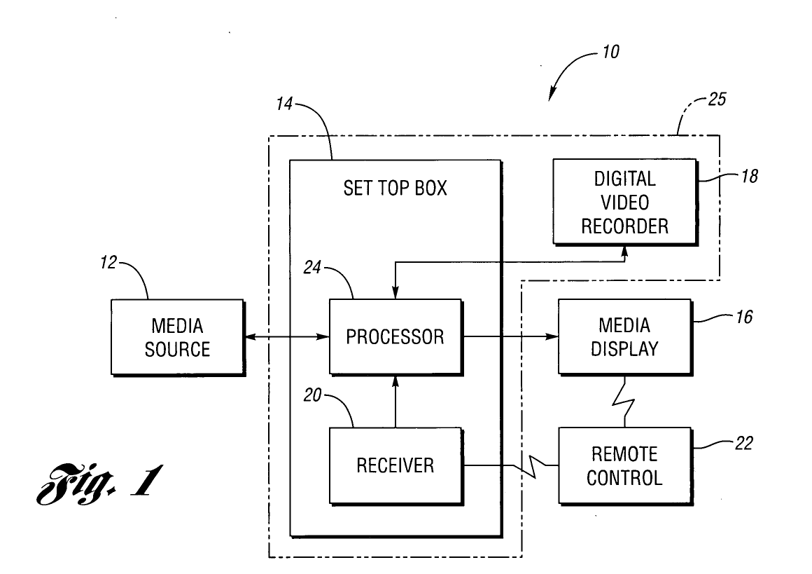

FIG. 1 shows a system 10 for managing a digital recording device in accordance with the present invention. System 10 includes a media source 12 for transmitting signals to a controller or transceiver, such as settop box (STB) 14, which provides signals to a display device 16, such as a television, monitor, or other suitable media display. STB 14 is also in communication with a digital recording device, such as a digital video recorder (DVR) 18.

Media source 12 may be any suitable source for providing program signals from a content provider, such as HBO®, SHOWTIME®, etc., to the STB 14. For example, media source 12 may be a cable television network, a telephone network, a satellite system, or a system that operates through the Internet/world wide web. Thus, transmission of program signals may occur via cables, satellites, wireless networks, and/or by any suitable means. Furthermore, the program signals may include video signals, audio signals, and program information associated with programs broadcast over the network or system.

STB 14 receives program signals from media source 12 and controls which programs are displayed on associated display device 16. STB 14 may also receive software from media source 12 for controlling operation of STB 14. Furthermore, STB 14 receives information from DVR 18 and transmits information to display device 16 for use in managing operation of DVR 18, as explained below in detail.

To facilitate the control of STB 14, a receiver 20 may be provided for receiving remote control signals from a remote control 22. Remote control 22 may transmit control signals via infrared, radio frequency, or other signaling technology. STB 14 may also include a processor 24 to interpret and act upon the signals received from media source 12 and/or receiver 20, and then in turn provide signals to display device 16 in accordance with the present invention.

STB 14 may be provided in a separate housing, or functional components of STB 14 may be included in another signal reception or processing device, such as a television receiver or a video cassette recorder. In one embodiment, for example, a television set may be provided with transceiver components of STB 14, as well as display device 16. As another example, STB 14 and DVR 18 may be combined in a common device or unit, such as controller 25, as shown in phantom lines in FIG. 1.

DVR 18 is in communication with STB 14 and is configured to digitally record program signals transmitted by media source 12 and/or any other video source. For example, DVR may be configured to record signals on a tape, fixed memory, and/or disk.

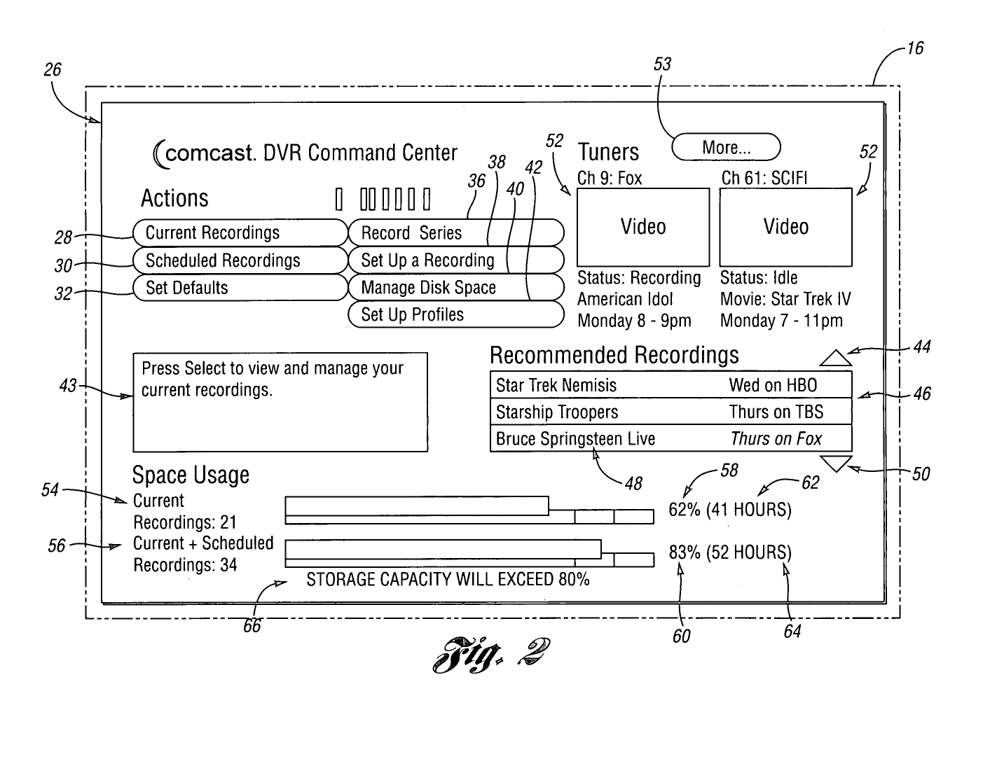

Referring to FIGS. 1 and 2, additional details regarding the operation of system 10 will now be described. The SBT 14 may be configured to manage operation of the DVR 18, and may be referred to as a DVR command center. For example, the SBT 14 may include necessary software and/or hardware for generating one or more user interface programming or management screens, such as management screen 26 shown in FIG. 2, on display device 16 for use in managing digital content of the DVR 18. As a more detailed example, processor 24 may receive information from media source 12 and DVR 18 and may transmit all necessary information or data to display device 16 for generating management screen 26. Processor 24 may also transmit control signals to DVR 18 for controlling operation of DVR 18 based on input received through use of management screen 26.

Management screen 26 may be called up on display device 16 in any suitable manner. For example, a system user, which may be a cable, telephone, or satellite service subscriber, for instance, may press a corresponding button on the remote control 22, tune to a designated management screen channel, or press optional buttons provided on STB 14.

In the embodiment shown in FIG. 2, management screen 26 includes multiple action widgets, such as buttons 28, 30, 32, 34, 36, 38, 40 and 42, that may be actuated to provide additional information and/or to control operation of the DVR 18. The buttons 28-42 may be actuated in any suitable manner, such as by the system user pressing arrows provided on remote control 22 in order to move a cursor on the management screen 26 to a desired button, and then pressing an enter or select key on remote control 22 to select the desired button. When the cursor moves to a particular button, the button may be differentiated from other buttons in any suitable manner, such as by being highlighted in yellow, or any other color, to indicate current cursor position. Furthermore, the management screen 26 may include an information window 43 that provides a description of the function offered by a particular button 28-42 when the cursor is on the particular button 28-42.

The buttons 28-42 may provide links to additional information and/or functions relating to DVR 18. Furthermore, such links may be presented on one or more additional programming or management screens. For example, Current Recordings button 28 may provide a link to a list of recordings stored on DVR 18, and Scheduled Recordings button 30 may provide a link to a list of scheduled recordings that the system user has programmed the DVR 18 to record at a later time. Each list may identify recordings by title or program name, for example. Each list may also include additional information such as length of recording, date of recording, or scheduled date and time of recording, etc.

As another example, Set Defaults button 32 may provide a link to one or more additional screens to set up DVR system defaults. For instance, Set Defaults button 32 may be used to set the amount of extended recording time per program.

In addition, Record a Series button 36 may provide a link to one or more additional screens to set up recording of an entire program series or a portion thereof, and Set Up a Recording button 38 may provide a link to one or more screens to set up recording of a particular program or episode. Each link may also provide information on scheduling conflicts for scheduled recordings, and options and/or instructions for resolving such conflicts.

Information regarding a program series or particular program within a series may be provided by media source 12 and downloaded to STB 14. Such information may be continuously updated by media source 12.

The management screen 26 may also provide a storage space management button, such as Manage Disk Space button 40, for managing current recordings on the DVR 18. When selected, the Manage Disk Space button 40 may provide a link to one or more additional screens that provide a listing of current recordings, recording time for each recording, and/or recommendations on recordings that may be deleted to free up storage capacity of the DVR 18. For example, the additional screen or screens may provide a listing of recordings that have not been viewed within a predetermined time period, and are, therefore, candidates for deletion.

Set Up Profiles button 42 may provide a link to one or more additional screens to set up a personal profile. For example, the system user may create a profile that indicates what type of programs he or she is interested in, such as sports programs, comedies, science fiction programs, etc. Such information may be used by the STB 14 to generate recommended recordings.

In that regard, management screen 26 may include a recommended recordings section 44 that provides a list 46 of recommended programs 48 for recording. Each recommended program 48 may be selected, such as by using the remote 22 or any other suitable means, to view additional information about the program 48 and/or to automatically set up recording of the program 48. Recommended recordings section 44 may also include one or more arrow buttons 50 that cause additional recommended programs for recording to be displayed when actuated.

STB 14 also transmits sufficient information to display device 16 in order to generate small scale (i.e., less than full screen size) video windows 52 on the management screen 26 that display program signals currently being decoded by multiple tuners of the system 10. More specifically, each video window 52 may display a program signal associated with a frequency or channel to which a corresponding tuner is currently tuned. Furthermore, each video window 52 may be selected, such as by using the remote 22 or any other suitable means, in order to switch to full screen presentation of the associated channel.

Additional information may also be presented with the video windows 52, such as an indication of the recording status of programs corresponding to the program signals, and program name of each program. A channel reference, such as channel number and/or name, may also be displayed proximate each video window 52. If the system user desires to view a different channel, the system user may actuate a button on management screen 26, such as “More . . . ” button 53, to change the channel displayed in one or more of the video windows 52.

Although only two video windows 52 are shown in FIG. 2, system 10 may be configured to display any number of video windows 52 on management screen 26. For example, STB 14 may be provided with three or more tuners such that three or more video windows 52 are displayed on management screen 26. As another example, management screen 26 may display video windows 52 associated with all tuners connected to the STB 14, such as via a network. In such an embodiment, additional information may be displayed below each video window 52 indicating the location of the associated tuner/device, such as “master bedroom,” “family room,” or other suitable user-created identifier.

Advantageously, the video windows 52 may be used to see what program or programs are currently being recorded by the DVR 18. Still further, the video windows may be used to preview recorded content to aid the system user when he is considering whether or not to delete a particular recording or recordings.

In addition, management screen 26 may provide status information regarding the DVR 18. For example, management screen 26 may include graphical and/or textual indicia regarding space usage of the DVR 18, such as consumed space and/or available space of the DVR 18. More specifically, for example, management screen 26 may include a current recordings indicator 54, which indicates the number of current recordings on the DVR 18; current plus scheduled recordings indicator 56, which indicates the number of current plus scheduled recordings; first storage capacity indicator 58, which may indicate percentage of storage capacity utilized by current recordings; second storage capacity indicator 60, which may indicate projected percentage of storage capacity utilized when both current and scheduled recordings are added together; first recording time indicator 62, which provides a first time quantity representing recording time of current recordings on the DVR 18; and second recording time indicator 64, which may provide a second time quantity representing recording time of current recordings plus scheduled recordings for the DVR 18. Thus, a time quantity for scheduled recordings may be obtained by subtracting first recording time indicator 62 from second recording time indicator 64. As another example, second recording time indicator 64 may represent recording time for scheduled recordings only.

In addition to, or as an alternative to the storage capacity percentages mentioned above, the storage capacity indicators 58 and 60 may include any suitable indicator means for conveying information regarding storage capacity of the DVR 18. In the embodiment shown in FIG. 2, for example, each storage capacity indicator 58 and 60 also includes a bar graph that displays the associated storage capacity of the DVR 18.

STB 14 may also generate a warning message 66 on management screen 26 when storage capacity of the DVR 18 reaches a predetermined level, or when storage capacity of the DVR 18 will reach a predetermined level based upon scheduled recordings. For example, the predetermined level may be a percentage of the total storage shown as an integer value, such as 90%.

When calculating the amount of available space on DVR 18, the type of programming (standard definition or high definition display resolution) may be considered by the STB 14 and/or DVR 18. While this calculation may not be absolutely accurate, an estimate of the consumed space can be calculated and represented as a percentage of consumed space or as a percentage of remaining space.

In addition, the STB 14 may offer options that enable the system user to move stored content to other storage devices in communication with the STB 14. For example, there may be devices, such as recorders, tethered or otherwise connected directly to the STB 14 and/or DVR 18, or devices that are connected to the STB 14 via a network. Furthermore, identifiers, such as metadata, associated with a stored recording on the DVR 18 may be used as a reference to another recording stored elsewhere, such as on another device on the network. Use of such identifiers may allow the system user to conserve storage space on the DVR 18 by referring to the recording in a peer location elsewhere. For instance, management screen 26 may prompt the user when an opportunity exists to make this reference when the user is requesting a new recording, or requesting to delete a recording. For example, a message may be presented on management screen 26 as follows: “You are about to delete a recording of a program that is already stored on the network. Would you like to maintain access to the network recording when deleting this recording from the DVR?”

System 10 may thus provide an efficient an effective means for controlling operation of the DVR 18. More specifically, STB 14 provides centralized management of the DVR 18, and generates an organized presentation of information relating to the DVR 18 on the display device 16. Furthermore, all main aspects or features of the DVR 18 may also be represented on a single programming or management screen, such as management screen 26, which may provide links to other screens that provide additional information and/or control features.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for managing a digital video recorder, the system comprising:
a transceiver for receiving program signals from a media source and for transmitting the program signals to a display device, the transceiver further being operative to transmit information regarding the digital video recorder to the display device to generate a user-interface management screen on the display device for use in managing operation of the digital video recorder, the information including data that is indicative of available recording space on the digital video recorder based on current and scheduled recordings.

2. The system of claim 1 wherein the information includes a first storage capacity indicator that represents percent of storage capacity of the digital video recorder utilized by current recordings, and a second storage capacity indicator that represents a projected percent of storage capacity utilized when both current and scheduled recordings are added together.

3. The system of claim 1 wherein the information includes a first time quantity representing recording time of current recordings on the digital video recorder, and a second time quantity that is indicative of recording time of scheduled recordings for the digital video recorder.

4. The system of claim 3 wherein the second time quantity represents recording time of current recordings plus projected recording time of scheduled recordings.

5. The system of claim 1 wherein the data that is indicative of available recording space is based on type of display resolution of the scheduled recordings.

6. The system of claim 1 wherein the information includes data that is indicative of available recording space on additional devices in communication with the transceiver.

7. The system of claim 1 wherein the transceiver and the digital video recorder are provided as one unit.

8. The system of claim 1 wherein the transceiver and the display device are provided as one unit.

9. The system of claim 1 wherein the transceiver is configured to transmit additional information regarding the digital video recorder to the display device for display on the display device, the additional information including number of current recordings and number of scheduled recordings.

10. The system of claim 1 wherein the transceiver is configured to generate a link on the management screen to a list of current recordings on the digital video recorder.

11. The system of claim 1 wherein the transceiver is configured to generate a link on the management screen to scheduled recordings for the digital video recorder.

12. The system of claim 1 wherein the transceiver is configured to generate a warning message on the management screen when storage capacity of the digital video recorder reaches a predetermined level, or when storage capacity will reach the predetermined level based upon scheduled recordings.

13. A system for managing a digital video recorder, the system comprising:
a transceiver for receiving program signals from a media source and for transmitting the program signals to a display device, the transceiver further being configured to transmit information regarding the digital video recorder to the display device to generate a user-interface management screen on the display device for use in managing the digital video recorder, such that the management screen includes a video window that displays one of the program signals, and such that the management screen includes the information regarding the digital video recorder.

14. The system of claim 13 wherein the information includes an indication of recording status of the one program signal.

15. The system of claim 14 wherein the information includes a program name corresponding to the one program signal.

16. The system of claim 13 wherein the transceiver and the digital video recorder are provided as one unit.

17. The system of claim 13 wherein the information includes a first time quantity representing recording time of current recordings on the digital video recorder, and a second time quantity that is indicative of recording time of scheduled recordings for the digital video recorder.

18. The system of claim 17 wherein the second time quantity represents recording time of current recordings and projected recording time of scheduled recordings.

19. The system of claim 13 wherein the information includes number of current recordings and number of scheduled recordings for the digital video recorder.

20. The system of claim 13 wherein the information includes an indication of available recording space on the digital video recorder.

21. The system of claim 20 wherein the information includes a first storage capacity indicator that represents percent of storage capacity of the digital video recorder utilized by current recordings, and a second storage capacity indicator that represents a projected percent of storage capacity utilized when both current and scheduled recordings are added together.

22. The system of claim 13 wherein the transceiver is configured to generate the management screen such that the management screen includes a link to current recordings of the digital video recorder.

23. The system of claim 13 wherein the transceiver is configured to generate the management screen such that the management screen includes a link to scheduled recordings for the digital video recorder.

24. The system of claim 13 wherein the transceiver is configured to generate the management screen such that the management screen includes multiple video windows that each display a different program signal.

25. A system for managing digital content on a digital video recorder, the system comprising:
a transceiver for receiving program signals from a media source and for transmitting information to a display device for generating a user-interface management screen on the display device for use in managing content on the digital video recorder, wherein the management screen is configured to include multiple video windows that display multiple program signals, and status information regarding the digital video recorder, the status information including number of current recordings, number of scheduled recordings, time of recorded material, time of recorded material plus scheduled recordings, percent of storage capacity utilized by current recordings, and percent of storage capacity utilized when both current and scheduled recordings are added together.

26. A method for managing a digital video recorder, the method comprising:
generating, via a transceiver, a user-interface management screen on a display device for use in managing operation of the digital video recorder, the management screen including data that is indicative of available recording space on the digital video recorder based on current and scheduled recordings, the transceiver further being operative to receive program signals from a media source and to transmit the program signals to the display device for display on the display device.
